(19) United States
(12) Patent Application Publication
(10) Pub. No.: US 2026/0031699 A1
(43) Pub. Date: Jan. 29, 2026

(54) SEMICONDUCTOR DEVICE AND POWER SUPPLY DEVICE

(71) Applicant: ROHM Co., LTD., Kyoto (JP)

(72) Inventor: Makoto Takahashi, Kyoto (JP)

(21) Appl. No.: 19/276,402

(22) Filed: Jul. 22, 2025

(30) Foreign Application Priority Data
Jul. 25, 2024 (JP) 2024-119631

(51) Int. Cl. H02M 1/00; H02M 1/088

(52) U.S. Cl. CPC H02M 1/0025; H02M 1/088

(57) ABSTRACT

Provided is a semiconductor device including an external terminal, an internal node, a control circuit configured to change an output according to a first voltage applied to the internal node, a current/voltage conversion element that is connected between the external terminal and the internal node, and a current generation circuit configured to flow a first current to the current/voltage conversion element such that a second voltage applied to the external terminal matches a predetermined third voltage.

### CROSS REFERENCE TO RELATED APPLICATIONS

This application claims priority benefit of Japanese Patent Application No. JP 2024-119631 filed in the Japan Patent Office on Jul. 25, 2024. Each of the above-referenced applications is hereby incorporated herein by reference in its entirety.

### BACKGROUND

The present disclosure relates to a semiconductor device and a power supply device.

Some semiconductor devices are provided with terminals, what is generally called low-active terminals that can raise an output as a terminal voltage is lower. In addition, some semiconductor devices are provided with terminals, what is generally high-active terminals that can raise an output as a terminal voltage is higher. For example, a phase compensation terminal of a typical power supply control integrated circuit (IC) is a low-active terminal in many cases.

It should be noted that, as an example of the past art related to the above, Japanese Patent Laid-Open No. 2018-164394 can be cited.

### BRIEF DESCRIPTION OF THE DRAWINGS

FIG. 1 is a diagram for depicting an overall configuration of a power supply device;

FIG. 2 is a diagram for depicting an overall configuration of a semiconductor device;

FIG. 3 is a diagram for depicting a comparative example of the semiconductor device;

FIG. 4 is a diagram for depicting behavior when an external terminal is short to ground in the comparative example;

FIG. 5 is a diagram for depicting a first embodiment of the semiconductor device;

FIG. 6 is a diagram for depicting behavior when an external terminal is short to ground in the first embodiment;

FIG. 7 is a diagram for depicting a state in which an output current becomes excessive in the first embodiment;

FIG. 8 is a diagram for depicting a second embodiment of the semiconductor device;

FIG. 9 is a diagram for depicting a state in which an output current is suppressed in the second embodiment; and

FIG. 10 is a diagram for depicting a third embodiment of the semiconductor device.

### DETAILED DESCRIPTION

### <Power Supply Device>

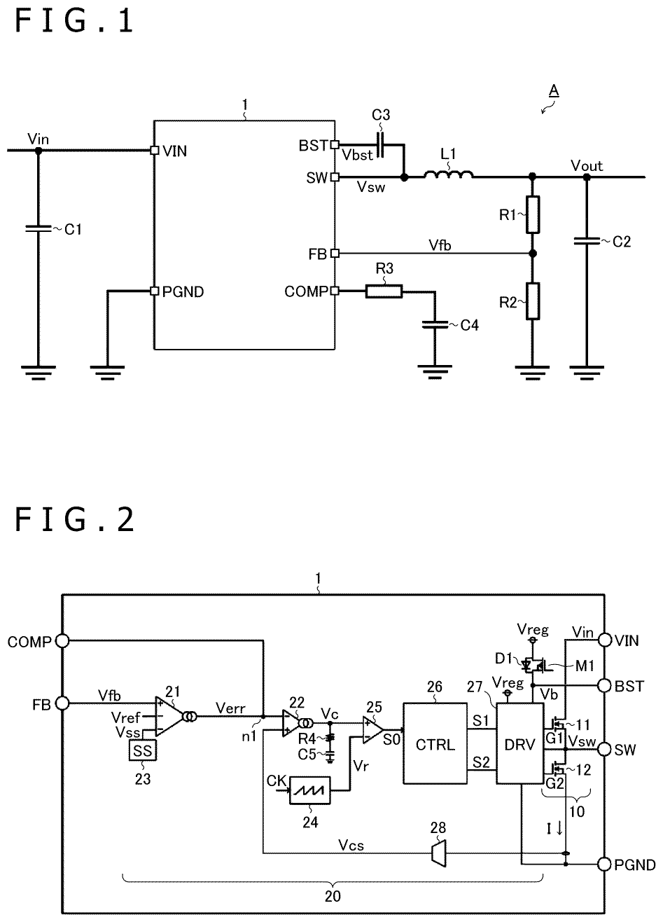

FIG. 1 is a diagram for depicting an overall configuration of a power supply device A. The power supply device A in the configuration example is a switching power supply, what is generally called a direct current (DC)/DC converter that steps down a DC input voltage Vin to generate a DC output voltage Vout. The power supply device A can be mounted in various applications such as vehicles and industrial machines.

Referring to the drawing, the power supply device A is provided with a semiconductor device 1 and various discrete components, for example, capacitors C1 to C4, an inductor L1, and resistors R1 to R3.

The semiconductor device 1 is a power supply control device, what is generally called a power supply control integrated circuit (IC) that can be the main controller of the power supply device A. The semiconductor device 1 is provided with, as a unit establishing electrical connection with components outside the device 1, a plurality of external terminals, for example, a bootstrap terminal BST, a phase compensation terminal COMP, a feedback terminal FB, a ground terminal PGND, a switch terminal SW, and an input terminal VIN. It should be noted that the semiconductor device 1 may be provided with external terminals other than those described above.

The input terminal VIN is connected to an application end of the input voltage Vin. The capacitor C1 is connected between the input terminal VIN and a ground end. The ground terminal PGND is connected to a ground end.

A first end of the capacitor C3 is connected to the bootstrap terminal BST. A second end of the capacitor C3 and a first end of the inductor L1 are connected to the switch terminal SW. A second end of the inductor L1 and a first end of each of the resistor R1 and the capacitor C2 are connected to an application end of the output voltage Vout. A second end of the resistor R1 and a first end of the resistor R2 are connected to the feedback terminal FB. A second end of each of the resistor R2 and the capacitor C2 is connected to a ground end.

The capacitor C3 functions as a part of a bootstrap circuit that generates a bootstrap voltage Vbst higher than a switch voltage Vsw applied to the switch terminal SW. The inductor L1 and the capacitor C2 function as a part of a rectifying/smoothing circuit that rectifies and smooths the pulse-like switch voltage Vsw to generate the output voltage Vout. The resistors R1 and R2 function as a voltage dividing circuit that divides the output voltage Vout to generate a feedback voltage Vfb (=Vout×R2/(R1+R2)).

A first end of the resistor R3 is connected to the phase compensation terminal COMP. A second end of the resistor R3 is connected to a first end of the capacitor C4. A second end of the capacitor C4 is connected to a ground end. The resistor R3 and the capacitor C4 function as a phase compensation circuit for preventing oscillation of an amplifier 21 (described later in detail) incorporated in the semiconductor device 1.

### <Semiconductor Device (Overall Configuration)>

FIG. 2 is a diagram for depicting an overall configuration of the semiconductor device 1. The semiconductor device 1 in the configuration example is provided with an output circuit 10 and a feedback control circuit 20.

The output circuit 10 generates the output voltage Vout from the input voltage Vin together with the external inductor L1 and capacitor C2. Referring to the drawing, the output circuit 10 includes transistors 11 and 12. The transistors 11 and 12 may be of an N-channel type.

A drain of the transistor 11 is connected to the input terminal VIN. A source of the transistor 11 is connected to the switch terminal SW. A gate of the transistor 11 is connected to an application end of an upper gate driving signal G1. The transistor 11 becomes an on-state when the upper gate driving signal G1 is at a high level (Vbst). The transistor 11 becomes an off-state when the upper gate driving signal G1 is at a low level (Vsw). The transistor 11 functions as an upper switch element for forming a half bridge output stage.

A drain of the transistor 12 is connected to the switch terminal SW. The source of the transistor 12 is connected to the ground terminal PGND. A gate of the transistor 12 is connected to an application end of a lower gate driving signal G2. The transistor 12 becomes an on-state when the lower gate driving signal G2 is at a high level (Vreg). The transistor 12 becomes an off-state when the lower gate driving signal G2 is at a low level (PGND). The transistor 12 functions as a lower switch element for forming a half bridge output stage.

The feedback control circuit 20 controls the output circuit 10 such that the feedback voltage Vfb according to the output voltage Vout matches a predetermined reference voltage Vref.

Referring to the drawing, the feedback control circuit 20 includes amplifiers 21 and 22, a soft start circuit 23, a ramp voltage generation circuit 24, a comparator 25, a controller 26, a driver 27, a current sensor 28, a capacitor C5, a diode D1, a transistor M1, and a resistor R4.

The amplifier 21 is an error amplifier that generates an error voltage Verr according to a difference between the feedback voltage Vfb input from the feedback terminal FB to a non-inverting input end (+) and a lower voltage between the reference voltage Vref input to a first inverting input end (−) and a soft start voltage Vss input to a second inverting input end (−). The error voltage Verr lowers when the feedback voltage Vfb is lower than the reference voltage Vref or the soft start voltage Vss. In contrast, the error voltage Verr rises when the feedback voltage Vfb is higher than the reference voltage Vref or the soft start voltage Vss. An output node of the amplifier 21 is connected to the phase compensation terminal COMP as an internal node n1. The amplifier 21 may be a transconductance amplifier, what is generally called a gm amplifier that generates a current signal flowing through the phase compensation terminal COMP.

The amplifier 22 generates a control voltage Vc according to a difference between the error voltage Verr input to an inverting input end (−) and a sensed voltage Vcs input to a non-inverting input end (+). The control voltage Vc rises when the error voltage Verr is lower than the sensed voltage Vcs, and lowers when the error voltage Verr is higher than the sensed voltage Vcs. The resistor R4 and the capacitor C5 for phase compensation may be connected between an output node of the amplifier 22 and a ground end. The amplifier 22 may be a transconductance amplifier, what is generally called a gm amplifier that generates a current signal flowing through the resistor R4 and the capacitor C5.

The soft start circuit 23 generates the soft start voltage Vss that slowly rises at a predetermined inclination when the semiconductor device 1 is started. The soft start voltage Vss can be adjusted so as to exceed the reference voltage Vref when a soft start time Tss has elapsed from the start of the rise.

The ramp voltage generation circuit 24 generates a triangular wave-like or sawtooth wave-like ramp voltage Vr that repeats rising and lowering in synchronization with a clock signal CK. The clock signal CK may be a rectangular wave signal that is pulse-driven at a predetermined switching period Tsw.

The comparator 25 compares, for example, the control voltage Vc input to a non-inverting input end (+) with the ramp voltage Vr input to an inverting input end (−) to generate a duty signal S0. The duty signal S0 becomes a high level when the control voltage Vc is higher than the ramp voltage Vr. In contrast, the duty signal S0 becomes a low level when the control voltage Vc is lower than the ramp voltage Vr.

The controller 26 generates an upper control signal S1 and a lower control signal S2 according to the clock signal CK and the duty signal S0. For example, the controller 26 may generate the upper control signal S1 and the lower control signal S2 so as to turn the transistor 11 on and the transistor 12 off at the timing when a pulse is generated in the clock signal CK. In addition, the controller 26 may generate the upper control signal S1 and the lower control signal S2 so as to turn the transistor 11 off and the transistor 12 on at the timing when the duty signal S0 falls from the high level to the low level, that is, the timing when the ramp voltage Vr exceeds the control voltage Vc. Thus, the controller 26 may generate the upper control signal S1 and the lower control signal S2 by using the clock signal CK as an on-timing decision signal and the duty signal S0 as an off-timing decision signal.

The driver 27 drives the output circuit 10 by generating the upper gate driving signal G1 and the lower gate driving signal G2 according to the upper control signal S1 and the lower control signal S2. For example, the driver 27 sets the upper gate driving signal G1 to the high level (Vbst) when the upper control signal S1 is at the high level (Vreg), and sets the upper gate driving signal G1 to the low level (Vsw) when the upper control signal S1 is at the low level (GND). In addition, for example, the driver 27 sets the lower gate driving signal G2 to the high level (Vreg) when the lower control signal S2 is at the high level (Vreg), and sets the lower gate driving signal G2 to the low level (PGND) when the lower control signal S2 is at the low level (GND).

It should be noted that the bootstrap voltage Vbst applied to the bootstrap terminal BST is generated by the diode D1, the transistor M1, and the external capacitor C3. The transistor M1 may be of a P-channel type. The diode D1 may be a body diode of the transistor M1. The anode of the diode D1 and a drain of the transistor M1 are connected to an application end of a constant voltage Vreg. A cathode of the diode D1 and a source of the transistor M1 are connected to the bootstrap terminal BST.

For example, when the transistor 11 is in an off-state and the transistor 12 is in an on-state, that is, when the switch voltage Vsw is at the low level (PGND), the transistor M1 becomes an on-state. At this time, the substantially constant voltage Vreg is charged between both ends of the capacitor C3. Therefore, the bootstrap voltage Vbst becomes a voltage value (=PGND+Vreg) that is higher than the switch voltage Vsw by the constant voltage Vreg.

Conversely, when the transistor 11 is in an on-state and the transistor 12 is in an off-state, that is, when the switch voltage Vsw is at the high level (Vin), the transistor M1 becomes an off-state. At this time, the voltage between both ends of the capacitor C3 is maintained at the substantially constant voltage Vreg by a charge storage law. Therefore, the bootstrap voltage Vbst becomes a voltage value (=Vin+Vreg) that is higher than the switch voltage Vsw by the constant voltage Vreg.

The current sensor 28 generates the sensed voltage Vcs according to an output current I flowing through the output circuit 10. For example, the current sensor 28 may detect the output current I flowing through the transistor 12. It should be noted that, in a case where a voltage mode control method is adopted instead of a current mode control method as the topology of the feedback control circuit 20, the amplifier 22 and the current sensor 28 may be omitted, and the error voltage Verr may be directly input to the non-inverting input end (+) of the comparator 25.

### Semiconductor Device (Comparative Example)

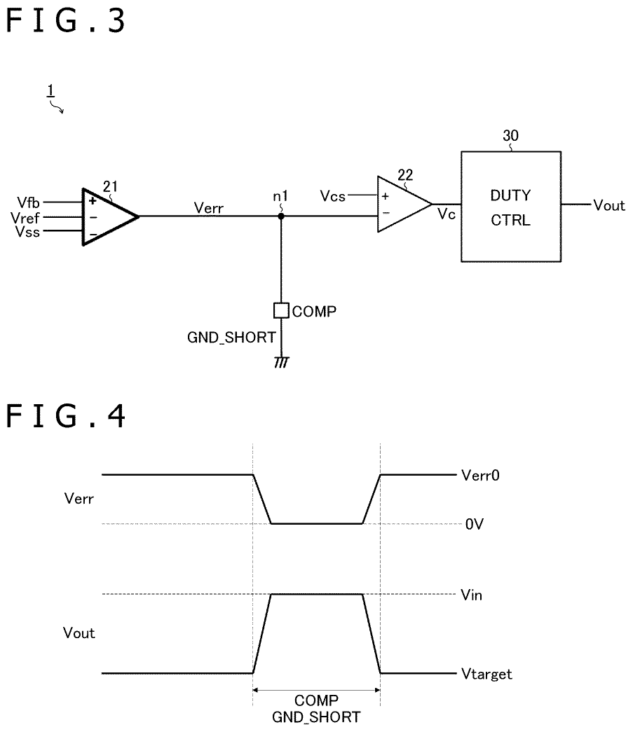

FIG. 3 is a diagram for depicting a comparative example (corresponding to a configuration example to be compared with embodiments described later) of the semiconductor device 1. In the drawing, peripheral circuits of the phase compensation terminal COMP, specifically, the amplifiers 21 and 22 and a duty control circuit 30 are illustrated as main parts of the semiconductor device 1.

It should be noted that the duty control circuit 30 illustrated in the post-stage of the amplifier 22 can be understood as a circuit block that combines the above-described output circuit 10 (including the external inductor L1 and capacitor C2) and a part of the feedback control circuit 20 (the controller 26 and the driver 27) into one.

The duty control circuit 30 controls an on-duty Don of the output circuit 10 such that the output voltage Vout is raised as the error voltage Verr applied to the phase compensation terminal COMP and further to the internal node n1 is lower. Therefore, the phase compensation terminal COMP can be understood as a terminal, what is generally called a low-active terminal that can raise the output voltage Vout as the terminal voltage is lower. It should be noted that the on-duty Don can be defined as, for example, the ratio (Don=Ton/Tsw) of an on-period Ton of the transistor 11 to a switching period Tsw.

Meanwhile, in the semiconductor device 1 of the comparative example, the phase compensation terminal COMP is directly connected to the internal node n1 to which the error voltage Verr is applied. Therefore, when a ground fault occurs in the phase compensation terminal COMP, the output voltage Vout may rise without being controlled. It should be noted that the ground fault in the specification can be understood as a short circuit to a ground end or an equivalent low potential end.

FIG. 4 is a diagram for depicting behavior in the semiconductor device 1 of the comparative example when the phase compensation terminal COMP is short to ground. The error voltage Verr is illustrated in the upper part of the drawing, and the output voltage Vout is illustrated in the lower part of the drawing.

As depicted in the drawing, the error voltage Verr lowers to 0 V when a ground fault occurs in the phase compensation terminal COMP. Therefore, in the duty control circuit 30, the on-duty Don of the output circuit 10 is increased to the maximum. As a result, the output feedback control for allowing the output voltage Vout to be matched to a target value Vtarget does not work, and the output voltage Vout rises to the vicinity of the input voltage Vin. If such an uncontrollable state occurs, it becomes difficult to ensure the safety of the post-stage circuit that receives the supply of the output voltage Vout.

In view of the above consideration, a first embodiment that can realize fail-safe in the case of a ground fault of the phase compensation terminal COMP will be proposed below.

### Semiconductor Device (First Embodiment)

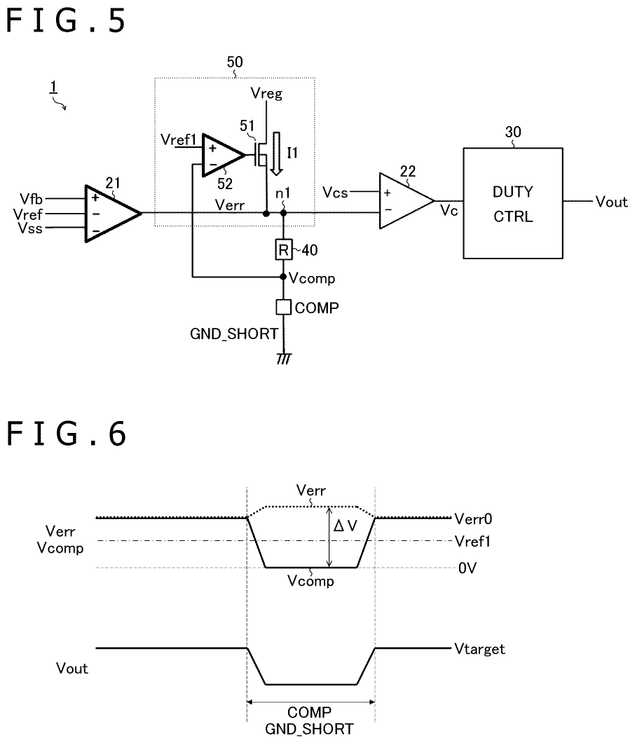

FIG. 5 is a diagram for depicting the first embodiment of the semiconductor device 1. The semiconductor device 1 of the present embodiment is further provided with a current/voltage conversion element 40 and a current generation circuit 50 on the basis of the above-described comparative example (FIG. 3).

The current/voltage conversion element 40 is connected between the phase compensation terminal COMP and the internal node n1. The current/voltage conversion element 40 may be, for example, a resistor element having a resistance value R.

The current generation circuit 50 flows a current I1 to the current/voltage conversion element 40 such that a terminal voltage Vcomp applied to the phase compensation terminal COMP matches to a predetermined reference voltage Vref1. Referring to the drawing, the current generation circuit 50 includes a transistor 51 and an amplifier 52. The transistor 51 may be of an N-channel type.

The transistor 51 is provided on a path through which the current I1 flows. Specifically, a drain of the transistor 51 is connected to the application end of the constant voltage Vreg. A source of the transistor 51 is connected to the internal node n1. Therefore, the current I1 flows from the application end of the constant voltage Vreg into the internal node n1 via the transistor 51, and further can flow in a direction from the internal node n1 toward the phase compensation terminal COMP via the current/voltage conversion element 40.

The amplifier 52 drives a gate of the transistor 51 such that the terminal voltage Vcomp input from the phase compensation terminal COMP to an inverting input end (−) matches the reference voltage Vref1 input to a non-inverting input end (+). Therefore, when the terminal voltage Vcomp is lower than the reference voltage Vref1, the current I1 having a magnitude corresponding to the difference value (=Vref1−Vcomp) between the terminal voltage Vcomp and the reference voltage Vref1 flows via the transistor 51. In contrast, when the terminal voltage Vcomp is higher than the reference voltage Vref1, the transistor 51 becomes an off-state and the path through which the current I1 flows is cut off.

FIG. 6 is a diagram for depicting behavior in the semiconductor device 1 of the first embodiment when the phase compensation terminal COMP is short to ground. The terminal voltage Vcomp (solid line) and the error voltage Verr (dashed line) are illustrated in the upper part of the drawing. The output voltage Vout is illustrated in the lower part of the drawing.

When a ground fault occurs in the phase compensation terminal COMP, the terminal voltage Vcomp lowers to 0 V as in FIG. 4. At this time, the current generation circuit 50 generates the current I1 in an attempt to raise the terminal voltage Vcomp to the reference voltage Vref1. Therefore, a potential difference ΔV (=I1×R) is generated between both ends of the current/voltage conversion element 40. That is, the potential difference ΔV is provided between the error voltage Verr and the terminal voltage Vcomp. Therefore, even if the terminal voltage Vcomp remains at 0 V, the error voltage Verr does not lower following the terminal voltage Vcomp. As a result, the output voltage Vout can be maintained in a controllable state.

For example, the potential difference ΔV generated between the error voltage Verr and the terminal voltage Vcomp may be set equal to or larger than an equilibrium value Verr0 of the error voltage Verr as depicted in the drawing. The equilibrium value Verr0 can be understood as the error voltage Verr obtained in a state where the output voltage Vout matches the target value Vtarget. According to such a setting, the error voltage Verr becomes higher than the equilibrium value Verr0 when a ground fault occurs in the phase compensation terminal COMP. Therefore, since the output voltage Vout is lowered from the target value Vtarget, the safety of the post-stage circuit that receives the supply of the output voltage Vout can be enhanced.

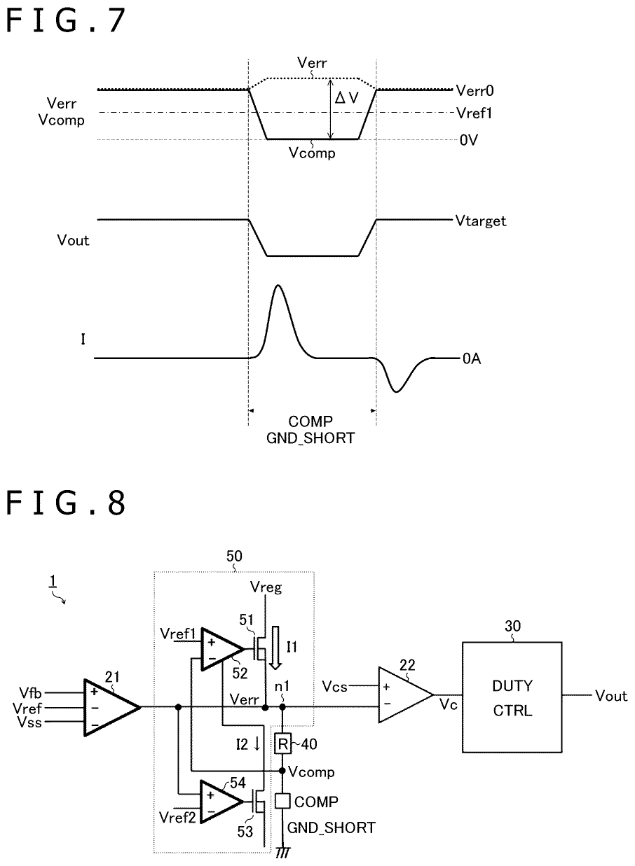

FIG. 7 is a diagram for depicting a state in which the output current I becomes excessive when a ground fault occurs in the phase compensation terminal COMP in the semiconductor device 1 of the first embodiment. The terminal voltage Vcomp (solid line) and the error voltage Verr (dashed line) are illustrated in the upper part of the drawing. The output voltage Vout is illustrated in the middle part of the drawing. The output current I is illustrated in the lower part of the drawing. The output current I is defined such that a direction from the switch terminal SW toward the transistor 12 is a positive direction.

As depicted in the drawing, in a ground fault protection operation of the phase compensation terminal COMP, the output current I rapidly fluctuates in order to lower the output voltage Vout. Therefore, the output current I may exceed an allowable upper limit value of the semiconductor device 1.

In view of the above consideration, a second embodiment that can suppress the output current I associated with the ground fault protection operation of the phase compensation terminal COMP will be proposed below.

### Semiconductor Device (Second Embodiment)

FIG. 8 is a diagram for depicting the second embodiment of the semiconductor device 1. The configuration and operation of the current generation circuit 50 are changed in the semiconductor device 1 of the present embodiment on the basis of the first embodiment (FIG. 5) described above.

The current generation circuit 50 adjusts a driving capability of the amplifier 52 such that the terminal voltage Vcomp matches a predetermined reference voltage Vref2. For example, the current generation circuit 50 further includes a transistor 53 and an amplifier 54 in addition to the transistor 51 and the amplifier 52 described above.

The transistor 53 is provided on a path through which a current I2 for adjusting the driving capability of the amplifier 52 flows. For example, the driving capability of the amplifier 52 becomes lower as the current I2 is larger, and becomes higher as the current I2 is smaller. In other words, as the current I2 is larger, the current I1 is narrowed to be small.

The amplifier 54 drives a gate of the transistor 53 such that the error voltage Verr input from the internal node n1 to an inverting input end (−) matches the reference voltage Vref2 input to a non-inverting input end (+). Therefore, when the error voltage Verr is higher than the reference voltage Vref2, the current I2 having a magnitude corresponding to the difference value (=Verr-Vref2) between the error voltage Verr and the reference voltage Vref2 flows via the transistor 53. In contrast, when the error voltage Verr is lower than the reference voltage Vref2, the transistor 53 becomes an off-state, and the path through which the current I2 flows is cut off.

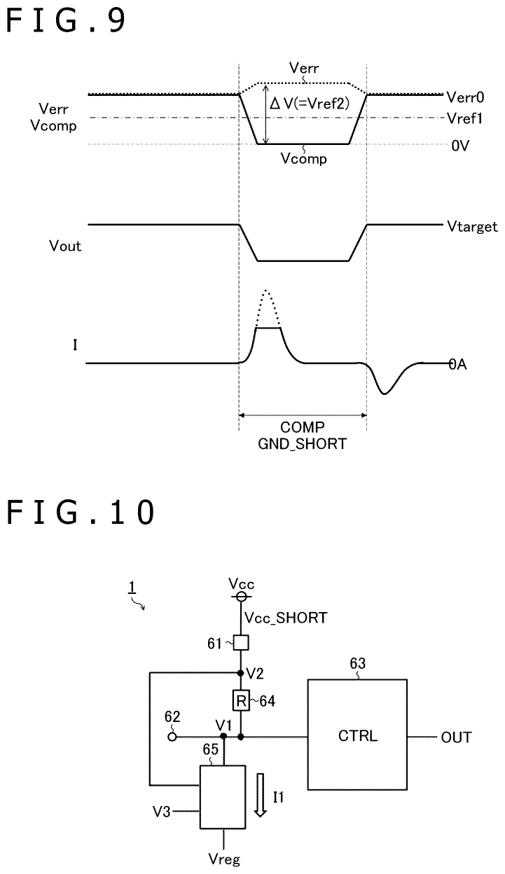

FIG. 9 is a diagram for depicting a state in which the output current I is suppressed when a ground fault occurs in the phase compensation terminal COMP in the semiconductor device 1 of the second embodiment. The terminal voltage Vcomp (solid line) and the error voltage Verr (dashed line) are illustrated in the upper part of the drawing. The output voltage Vout is illustrated in the middle part of the drawing. The output current I is illustrated in the lower part of the drawing. The output current I is defined such that the direction from the switch terminal SW toward the transistor 12 is the positive direction.

As depicted in the drawing, the addition of the transistor 53 and the amplifier 54 causes the error voltage Verr to rise up to the reference voltage Vref2 as an upper limit. As a result, since an upper limit value is set for the output current I, the output current I hardly exceeds the allowable upper limit value of the semiconductor device 1.

### Semiconductor Device (Third Embodiment)

FIG. 10 is a diagram for depicting a third embodiment of the semiconductor device 1. The semiconductor device 1 of the third embodiment is provided with an external terminal 61, an internal node 62, a control circuit 63, a current/voltage conversion element 64, and a current generation circuit 65.

The external terminal 61 can be understood as a terminal, what is generally called a high-active terminal that can raise an output OUT as a terminal voltage V2 is higher. The internal node 62 is a node to which a node voltage V1 is applied. The control circuit 63 raises the output OUT as the node voltage V1 is higher. The current/voltage conversion element 64 is connected between the external terminal 61 and the internal node 62. The current generation circuit 65 flows the current I1 to the current/voltage conversion element 64 such that the terminal voltage V2 applied to the external terminal 61 matches a predetermined reference voltage V3. Referring to the drawing, the current generation circuit 65 flows the current I1 in a direction from the external terminal 61 toward the internal node 62 via the current/voltage conversion element 64.

In the configuration, when a power short occurs in the external terminal 61, a potential difference ΔV is provided between the node voltage V1 and the terminal voltage V2. Therefore, even if the terminal voltage V2 remains at the power supply voltage Vcc, the node voltage V1 does not rise following the terminal voltage V2. As a result, the output OUT can be maintained in a controllable state. It should be noted that the “power short” in the specification can be understood as a short circuit to a power supply end or an equivalent high-potential end.

### <Supplementary Note>

In the semiconductor device according to the present disclosure, fail-safe can be realized when the external terminal is short-circuited, for example, when a ground fault occurs in the low-active terminal and when a power short occurs in the high-active terminal. In the following, supplementary notes are given to the above disclosure.

### (Note 1)

A semiconductor device (1) including:
an external terminal (COMP, 61);
an internal node (n1, 62);
a control circuit (30, 63) configured to change an output (Vout, OUT) according to a first voltage (Verr, V1) applied to the internal node (n1, 62);
a current/voltage conversion element (40, 64) that is connected between the external terminal (COMP, 61) and the internal node (n1, 62); and
a current generation circuit (50, 65) configured to flow a first current (I1) to the current/voltage conversion element (40, 64) such that a second voltage (Vcomp, V2) applied to the external terminal (COMP) matches a predetermined third voltage (Vref1, V3).

### (Note 2)

The semiconductor device (1) according to Note 1,
in which the control circuit (30) raises the output (Vout) as the first voltage (Verr) is lower, and
the current generation circuit (50) flows the first current (11) in a direction from the internal node (n1) toward the external terminal (COMP) via the current/voltage conversion element (40).

### (Note 3)

The semiconductor device (1) according to Note 1,
in which the control circuit (63) raises the output (OUT) as the first voltage (V1) is higher, and
the current generation circuit (65) flows the first current (I1) in a direction from the external terminal (61) toward the internal node (62) via the current/voltage conversion element (64).

### (Note 4)

The semiconductor device (1) according to any one of Notes 1 to 3,
in which the current generation circuit (50) includes
   a first transistor (51) that is provided on a path through which the first current (11) flows, and
   a first amplifier (52) configured to drive the first transistor (51) such that the second voltage (Vcomp) matches the third voltage (Vref1). (Note 5)

The semiconductor device (1) according to Note 4,
in which the current generation circuit (50) adjusts a driving capability of the first amplifier (52) such that the second voltage (Vcomp) matches a predetermined fourth voltage (Vref2).

### (Note 6)

The semiconductor device (1) according to Note 5,
in which the current generation circuit (50) includes
   a second transistor (53) that is provided on a path through which a second current (12) for adjusting the driving capability of the first amplifier (52) flows, and
   a second amplifier (54) configured to drive the second transistor (53) such that the second voltage (Vcomp) matches the fourth voltage (Vref2).

### (Note 7)

The semiconductor device (1) according to any one of Notes 1 to 6, including:
an output circuit (10, L1, C2) configured to generate an output voltage (Vout) from an input voltage (Vin); and
a feedback control circuit (20) configured to control the output circuit (10) such that a feedback voltage (Vfb) according to the output voltage (Vout) matches a predetermined reference voltage (Vref),
in which the control circuit (30) is a part of the output circuit (10) and the feedback control circuit (20). (Note 8)

The semiconductor device (1) according to Note 7,
in which the feedback control circuit (20) includes an error amplifier (21) configured to generate an error voltage (Verr) according to a difference between the feedback voltage (Vfb) and the reference voltage (Vref), and
the internal node (n1) is an output node of the error amplifier (21), the first voltage (Verr) is the error voltage (Verr), and the external terminal (COMP) is a phase compensation terminal (COMP) of the error amplifier (21).

### (Note 9)

The semiconductor device (1) according to Note 8,
in which the feedback control circuit (20) includes
   a ramp voltage generation circuit (24) configured to generate a ramp voltage (Vr),
   a comparator (25) configured to generate a duty signal (SO) by comparing the error voltage (Verr) or the corresponding control voltage (Vc) with the ramp voltage (Vr),
   a controller (26) configured to generate a control signal (S1, S2) according to the duty signal (SO), and
   a driver (27) configured to drive the output circuit (10) according to the control signal (S1, S2).

### (Note 10)

A power supply device (A) including:
the semiconductor device (1) according to any one of Notes 7 to 9.

### <Others>

It should be noted that, in addition to the above embodiments, various technical features disclosed in the specification can variously be changed in a range that does not deviate from the spirit of the technical creation. That is, the above embodiments should be considered to be exemplary and not restrictive in all respects. In addition, the technical scope of the present disclosure is defined by the claims, and should be understood to include meanings equivalent to the claims and all changes that belong to the scope.

What is claimed is:

1. A semiconductor device comprising:
an external terminal;
an internal node;
a control circuit configured to change an output according to a first voltage applied to the internal node;
a current/voltage conversion element that is connected between the external terminal and the internal node; and
a current generation circuit configured to flow a first current to the current/voltage conversion element such that a second voltage applied to the external terminal matches a predetermined third voltage.

2. The semiconductor device according to claim 1,
wherein the control circuit raises the output as the first voltage is lower, and
the current generation circuit flows the first current in a direction from the internal node toward the external terminal via the current/voltage conversion element.

3. The semiconductor device according to claim 1,
wherein the control circuit raises the output as the first voltage is higher, and
the current generation circuit flows the first current in a direction from the external terminal toward the internal node via the current/voltage conversion element.

4. The semiconductor device according to claim 1,
wherein the current generation circuit includes
a first transistor that is provided on a path through which the first current flows, and
a first amplifier configured to drive the first transistor such that the second voltage matches the third voltage.

5. The semiconductor device according to claim 4,
wherein the current generation circuit adjusts a driving capability of the first amplifier such that the second voltage matches a predetermined fourth voltage.

6. The semiconductor device according to claim 5,
wherein the current generation circuit includes
a second transistor that is provided on a path through which a second current for adjusting the driving capability of the first amplifier flows, and
a second amplifier configured to drive the second transistor such that the second voltage matches the fourth voltage.

7. The semiconductor device according to claim 1, comprising:
an output circuit configured to generate an output voltage from an input voltage; and
a feedback control circuit configured to control the output circuit such that a feedback voltage according to the output voltage matches a predetermined reference voltage,
wherein the control circuit is a part of the output circuit and the feedback control circuit.

8. The semiconductor device according to claim 7,
wherein the feedback control circuit includes an error amplifier configured to generate an error voltage according to a difference between the feedback voltage and the reference voltage, and
the internal node is an output node of the error amplifier, the first voltage is the error voltage, and the external terminal is a phase compensation terminal of the error amplifier.

9. The semiconductor device according to claim 8,
wherein the feedback control circuit includes
a ramp voltage generation circuit configured to generate a ramp voltage,
a comparator configured to generate a duty signal by comparing the error voltage or the corresponding control voltage with the ramp voltage,
a controller configured to generate a control signal according to the duty signal, and
a driver configured to drive the output circuit according to the control signal.

10. A power supply device comprising:
the semiconductor device according to claim 7.
